(19) United States
(12) Patent Application Publication
(10) Pub. No.: US 2008/0098155 A1
(43) Pub. Date: Apr. 24, 2008

(54) DOWNLOAD APPARATUS AND METHOD THEREFOR

(75) Inventors: Hua-Dong Cheng, Shenzhen City (CN); Wen-Chuan Lian, Shenzhen City (CN); Han-Che Wang, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/874,196

(22) Filed: Oct. 17, 2007

(30) Foreign Application Priority Data
Oct. 18, 2006 (CN) 200610063158.9

(51) Int. Cl. G06F 12/00

(52) U.S. Cl. 711/100; 711/E12.001

(57) ABSTRACT

A file download method adapted for a download apparatus is provided. The apparatus includes a storage unit for storing connection data and search fields, the connection data specifies an external device which the apparatus connects to, and the search fields are used as download conditions for downloading files from the external device connected thereto. The method includes: reading the connection data; connecting the apparatus to the external device according to the connection data; reading the search fields; searching the connected external device for files that match the read search fields; and downloading the matched files. A related download apparatus is also provided.

### BACKGROUND

1. Technical Field

The present invention relates to an electronic apparatus, and particularly to an electronic apparatus for downloading files from an external device, and a method therefor.

2. General Background

Electronic devices such as multimedia players, personal digital assistants (PDAs), are widely used. These electronic devices play video and/or audio files, display pictures and text files, etc. Users typically connect the electronic devices to external sources (e.g., computers, data servers, etc.), to search for desired files, and download the files to their device. Furthermore, if certain properties of the downloaded file are incompatible with the requirements of the corresponding application on the device, users have to manually modify the properties of the downloaded file to make the downloaded files usable. For example, if a device can only display image files whose format is “Joint Photographic Experts Group (JPG)”, if the format of a downloaded image file is “bitmap (BMP)”, the device cannot display the downloaded image file. Users have to change the format of the image file from “BMP” into “JPG”. Such manual operations described above would be troublesome to users.

What is needed, therefore, is an apparatus and method therefor, through which data files can be downloaded automatically and be modified so that the downloaded files can be usable.

### SUMMARY

A download apparatus is provided. The apparatus includes an interface for connecting to an external device, and a storage unit for storing connection data and search fields. The apparatus further includes a microcontroller unit (MCU). The MCU includes a connection module for reading the connection data, connecting to an external device according to the connection data; and a download module for reading the search fields, searching the connected external device for files that match the read search fields, and downloading the matched files into the storage unit.

A file download method adapted for a download apparatus is also provided. The apparatus includes a storage unit for storing connection data and search fields, the method includes: reading the connection data; connecting the apparatus to an external device according to the connection data; reading the search fields; searching the connected external device for files that match the read search fields; and downloading the matched files.

Other advantages and novel features will be drawn from the following detailed description with reference to the attached drawing.

### BRIEF DESCRIPTION OF THE DRAWINGS

FIG. 1 is a block diagram of a hardware infrastructure of a download apparatus;

FIG. 2 is a schematic diagram of search fields;

FIG. 3 is a schematic diagram of destination file properties; and

FIG. 4 is a flowchart of a method for downloading files.

### DETAILED DESCRIPTION OF THE EMBODIMENT

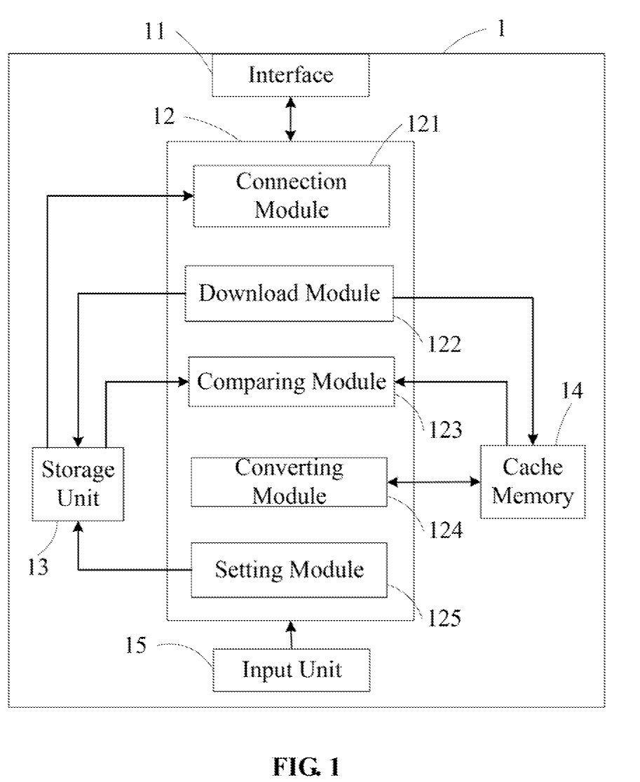

FIG. 1 is a block diagram of a hardware infrastructure of a download apparatus in accordance with a preferred embodiment of the present invention. The apparatus 1 is capable of automatically downloading data files (e.g., image files, audio files, text files, and video files) from external devices (e.g., computers, data servers, etc.). The apparatus 1 includes an interface 11, a microcontroller unit (MCU) 12, a storage unit 13, a cache memory 14, and an input unit 15. The interface 11 is configured for connecting to the external devices. The interface 11 can be wired (e.g., Universal Serial Bus (USB)) or wireless connections (e.g., Bluetooth, Institute of Electrical and Electronics Engineers 802.11 (IEEE 802.11)). The input unit 15 is typically a keypad, touchpad, or pointing device (e.g., mouse).

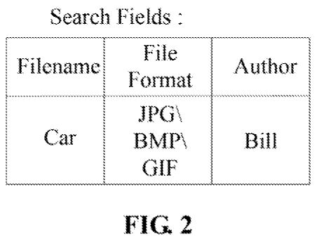

The storage unit 13 is configured for storing connection data and search fields. The connection data can be an Internet protocol (IP) address, a uniform resource locator (URL), or any other type of addressable connection that specifies the external device. The search fields are used as download conditions for downloading files from the externally connected device. The search fields (see FIG. 2) include, but not limited to, a filename, a file format, an author of a file, and a creation time of a file.

The MCU 12 includes a connection module 121, a download module 122, a comparing module 123, a converting module 124, and a setting module 125. When a predetermined event is triggered, for example, the apparatus 1 is powered on or a system time of the apparatus 1 reaches a predetermined time, etc., the connection module 121 automatically reads the connection data from the storage unit 13, and controls the apparatus 1 to connect to the external device through the interface 11 according to the connection data.

After the apparatus 1 connects to the external device, the download module 122 reads the search fields from the storage unit 13, and searches the external device for files that match the search fields. For example, if the filename, the author, and the file format search fields are “car”, “Bill”, and “all image file format” respectively, the download module 122 searches the external device for all image files named “car”, and created by “Bill”. If the download module 122 finds any matched files, the download module 122 further downloads the matched files to the cache memory 14.

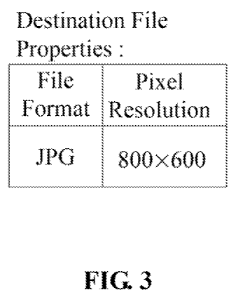

The storage unit 13 further stores destination file properties (see FIG. 3). After the matched file is downloaded to the cache memory 14 (hereafter downloaded file), the comparing module 123 reads the destination file properties, and compares properties of the downloaded file with the destination file properties, so as to determine whether the properties of the downloaded file match the destination file properties.

If the properties of the downloaded file match the destination file properties, the download module 122 stores the downloaded file into the storage unit 13. If the properties of the downloaded file do not match the destination file properties, the converting module 124 converts the properties of the downloaded file to the destination file properties, so as to have the properties of the download file matched the destination file properties.

For example, if the destination file properties is configured to be “JPG” file format and a “800×600” pixel resolution, and corresponding properties of the downloaded file are a “BMP” file format and a “1024×768” pixel resolution, the converting module 124 converts the file format and the pixel resolution properties of the downloaded file to “JPG” and “800×600”, thereby converting the properties of the downloaded file to match the destination file properties.

The setting module 125 is configured for modifying the connection data, the search fields, and the destination file properties according to user inputs through the input unit 15.

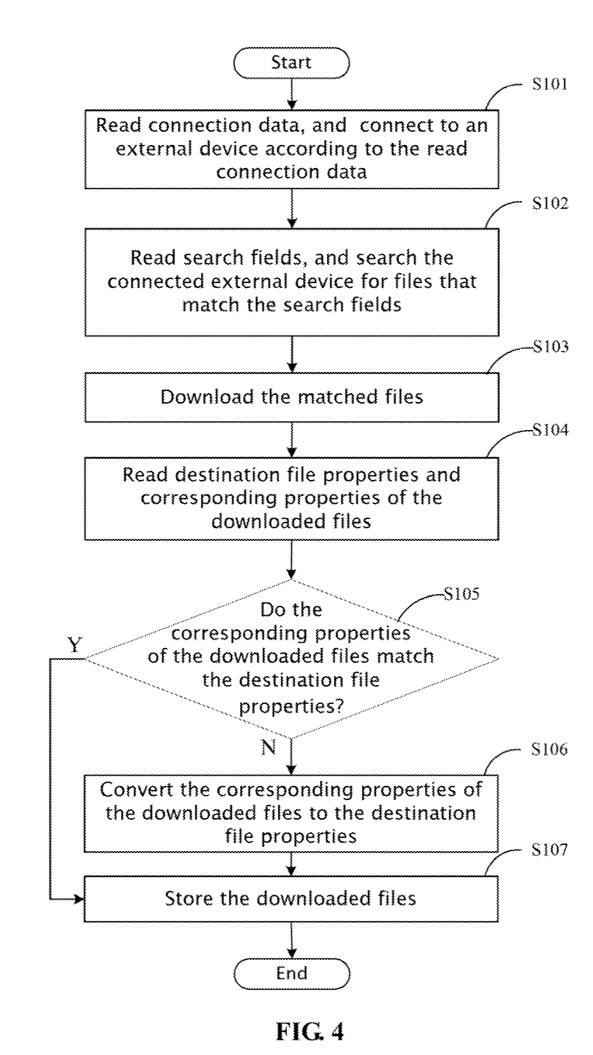

FIG. 4 is a flowchart of a method for downloading files through utilizing the apparatus 1 in accordance with a preferred embodiment of the present invention.

In step S101, the connection module 121 reads the connection data from the storage unit 13, and controls the apparatus 1 to connect to the external device through the interface 11 according to the connection data.

In step S102, the download module 122 reads the search fields from the storage unit 13, and searches the external device connected thereto for the files that match the search fields.

In step S103, the download module 122 downloads the matched files to the cache memory 14.

In step S104, the comparing module 123 reads the destination file properties and the corresponding properties of the downloaded files.

In step S105, the comparing module 123 determines whether the corresponding properties of the downloaded files match the destination file properties.

If the corresponding properties of the downloaded files match the destination file properties, the procedure goes to step S107 described below.

If the corresponding properties of the downloaded files do not match the destination file properties, in step S106, the converting module 124 converts the corresponding properties of the downloaded files to the destination file properties.

In step S107, the download module 122 stores the downloaded files into the storage unit 13.

Thus, by utilizing the apparatus 1 shown in FIG. 1, data files can be downloaded automatically, and the properties of the downloaded files can be modified so as to be supported and used by the apparatus 1.

Although the present invention has been specifically described on the basis of a preferred embodiment including a preferred method thereof, the invention is not to be construed as being limited thereto. Various changes or modifications may be made to the embodiment including the method without departing from the scope and spirit of the invention.

What is claimed is:

1. A download apparatus comprising:
an interface configured for connecting to an external device;
a storage unit configured for storing connection data and search fields, wherein the connection data is configured for specifying the external device which the download apparatus connects to, and the search fields are used as download conditions for downloading files from the external device; and
a microcontroller unit (MCU) comprising:
a connection module configured for reading the connection data, and connecting to the external device through the interface according to the connection data; and
a download module configured for reading the search fields, searching the external device connected thereto for files that match the read search fields, and downloading the matched files into the storage unit.

2. The apparatus according to claim 1, wherein the connection data is selected from the group consisting of an Internet protocol (IP) address and a uniform resource locator (URL).

3. The apparatus according to claim 1, wherein the MCU further comprises a comparing module and a converting module, the storage unit further stores destination file properties, wherein the comparing module is configured for comparing corresponding properties of downloaded files with the destination file properties, the converting module is configured for converting the corresponding properties of the downloaded files, to the destination file properties, when the corresponding properties of the downloaded files do not match the destination file properties.

4. The apparatus according to claim 3, wherein the MCU further comprises a setting module configured for modifying the connection data, the search fields, and the destination file properties.

5. A file download method adapted for a download apparatus, the apparatus comprising a storage unit for storing connection data and search fields, wherein the connection data specifies an external device which the apparatus connects to, and the search fields are used as download conditions for downloading files from the external device connected thereto, the method comprising:
reading the connection data;
connecting the apparatus to the external device according to the connection data;
reading the search fields;
searching the external device connected thereto for files that match the read search fields; and
downloading the matched files.

6. The method according to claim 5, further comprising:
comparing corresponding properties of downloaded files with destination file properties;
converting the corresponding properties of the downloaded file to the destination file properties when the corresponding properties of the downloaded files do not match the destination file properties.

7. The method according to claim 5, further comprising:
modifying the connection data, the search fields, and the destination file properties.
